(19) United States
(12) Patent Application Publication
(10) Pub. No.: US 2005/0084703 A1
(43) Pub. Date: Apr. 21, 2005

(54) Structural component

(76) Inventor: Michael Ashmead, Huntington, (GB)

Correspondence Address: SHERIDAN ROSS PC, 1560 BROADWAY, SUITE 1200, DENVER, CO, 80202, US

(21) Appl. No.: 10/499,400

(22) PCT Filed: Dec. 20, 2002
(86) PCT No.: PCT/GB02/05831

(30) Foreign Application Priority Data
Dec. 21, 2001 (GB) 0130669.5

(51) Int. Cl. B32B 3/12; B32B 3/30

(52) U.S. Cl. 428/593; 428/594; 428/603; 29/897.32

(57) ABSTRACT

A composite structural component for use in bearing a static load and a method of making same. The component comprises a non-planar member (1) in the form of a sheet which has a pattern of projections (3, 5) extending from at least one face of the sheet and a planar skin (11) which is bonded to one side of the non-planar member (1). The projections may be frustoconical with substantially flat tops (7).

The invention relates to a composite structural component which is for use as a support structure particularly, but not exclusively, in buildings or the like constructions.

A standard composite component is formed from a core sandwiched between two skins. However, the manufacture of such composite components may be time consuming and expensive.

It is an object of the present invention to provide an improved composite structural component.

According to the invention there is provided a composite structural component for use in bearing a static load, consisting of a non-planar member in the form of a sheet which has a pattern of projections extending from at least one face of the sheet and a planar skin which is bonded to one side of the non-planar member.

Thus, the structure is simplified in contrast to a standard composite component.

The pattern and parameters of the projections may be selected to provide a rigid structural component which has a high load-bearing capacity and is particularly resistant to shear. The parameters to be selected may be taken from the group consisting of geometry of each projection, material of the sheet and/or skin, thickness of the sheet and/or skin, nature of the bond between the non-planar member and skin and extent of contact between the non-planar member and skin. The nature of the bond and the contact area appear to be the critical parameters.

By bonding a planar skin to the non-planar member, the torsional rigidity and shear resistance of the non-planar member may be greatly improved. There is a synergistic effect with the torsional rigidity and shear strengths of the composite being significantly greater (eg at least 100% greater) than the sum of the component parts.

The planar skin may be attached to all or most, for example at least 80%, of the projections which extend from one face of the sheet of the non-planar member. The planar skin may be attached using welding or adhesive, e.g. polyurethane or epoxy adhesives.

The parameters of the projections which may be selectively adapted, including the height, diameter, cross-section, material and other characteristics of the projections. The projections may all be the same shape or alternatively, may be different, e.g. in height, in shape or other parameters as desired. The projections may, for example, be domed, pyramidal or frusto-conical. The projections preferably have a flat top surface whereby the contact area between the non-planar member and skin is maximised. Alternatively, the projections may have a rounded top surface.

Each projection may be hollow and may have a flat end face which extends parallel to the median plane. The median plane may be flat or curved. The pitch region may be at an angle of 15 to 90 degrees, preferably 25 to 60 degrees, to the median plane at a position of maximum steepness in the pitch region. The position of maximum steepness may occur midway between the centres of the adjacent front and rear projections.

The pattern may be selected so that the projections cover at least 80% of the area of the non-planar member leaving no substantial areas therebetween. There may be projections extending from both faces of the sheet of the non-planar member, i.e. forming front and rear projections. The position of maximum steepness may occur midway between adjacent front and rear projections. The non-planar member may have a smooth transition from one front peak to an adjacent rear peak in the pitch region. The projections may be arranged to alternate in two directions in the median plane.

The pattern may be adapted by changing projection interpitch, i.e. distance between two projections extending from the same face of the sheet. The pattern may be adapted so that there are the same or different number of front projections adjacent to every rear projections. There may be a pattern of alternating front and rear projections. The pattern may effect shear strength. However, parameters such as contact area between the planar skin and the non-planar member and density of projections may be more critical to shear strength. Nevertheless, projection geometry may be significant since a sloppy cell may shear more easily.

The non-planar member and the planar skin may be made of the same material or may be made of different materials. The material may be selected from the group consisting of aluminium, alloys where aluminium is the predominant component or thermoplastics, such as polycarbonate or polyamide. Alternatively, other metals or metal alloys may be used.

A method of making a composite structural component comprises providing a blank of sheet material, acting on the blank to deform the blank into a non-planar member having a pattern of projections extending from at least one face of the sheet and bonding a planar skin to the non-planar member. The non-planar member is thus a three-dimensional form and may have a pattern of alternating front and rear projections extending in front of and behind a median plane of the sheet. The pattern and characteristics of the projections may be selected so that the non-planar has a dual functionality and acts both as a core and a second skin.

The blank and the planar skin may be provided on adjacent rolls and may be unrolled simultaneously.

The deforming step may comprise a pressing operation. A solid lubricant may be used between the mould and the sheet to make pressing easier. The solid lubricant can be thin plastic sheet. The planar sheet may be bonded by soldering, welding or using an adhesive layer. The structure may be anodised at high temperature.

A specific embodiment of the invention will now be described in detail, by way of example, and with reference to the accompanying drawings in which:

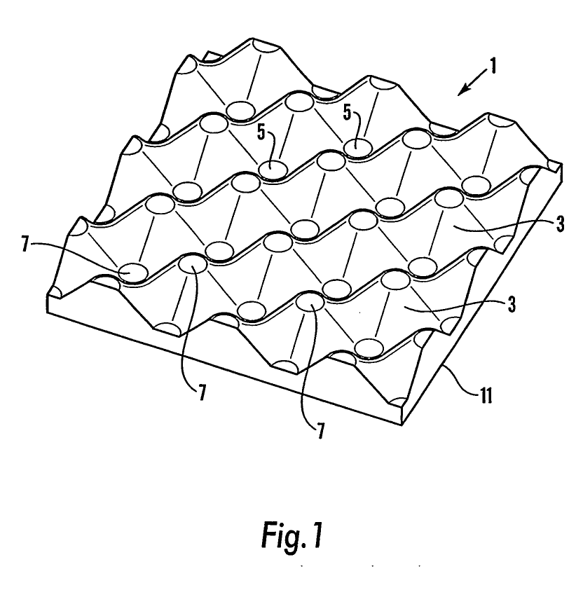

FIG. 1 shows a perspective view of a first structure according to the invention, the structure comprising a non-planar member;

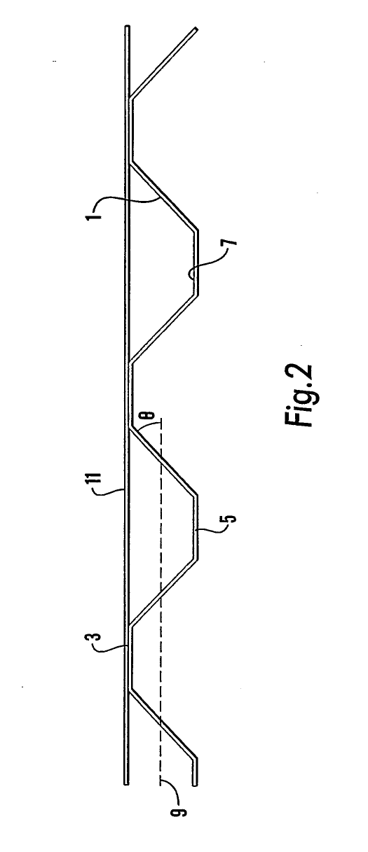

FIG. 2 is a side view of the structure shown in FIG. 1;

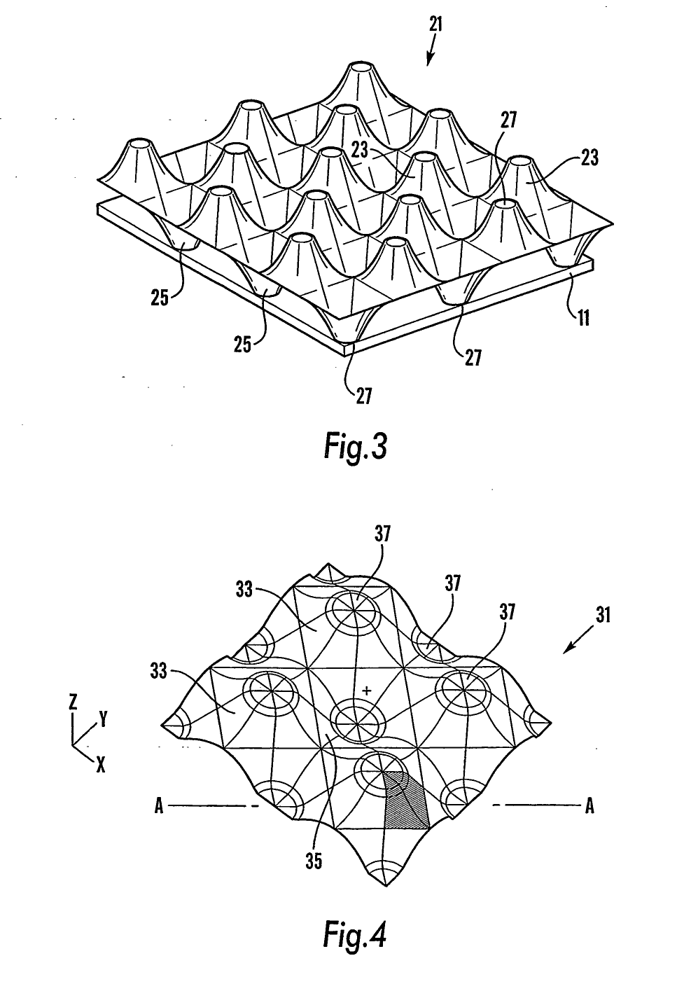

FIG. 3 shows a perspective view of a second structure according to the invention;

FIG. 4 is a schematic perspective view of the non-planar member of FIGS. 1 or 3;

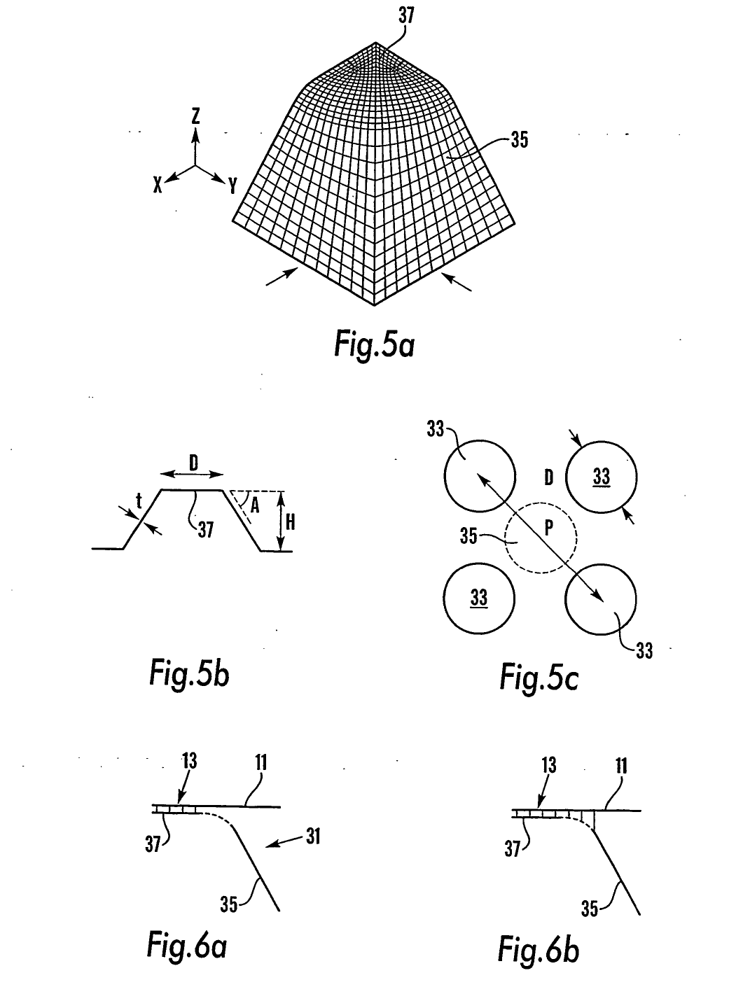

FIG. 5a is a side view of the shaded section of FIG. 4;

FIG. 5b is a cross-section along line AA of FIG. 4;

FIG. 5c is a schematic plan view of a section of FIG. 4;

FIGS. 6a and 6b show two cross-sections of sections of the structures of FIGS. 1 or 3;

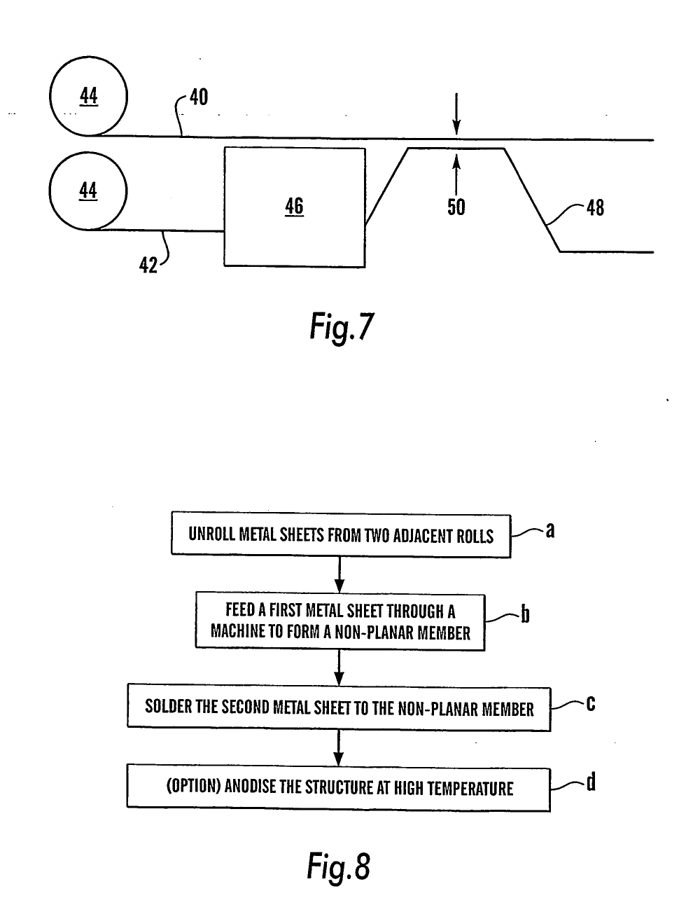

FIG. 7 is a schematic of a system for manufacturing a structure according to the invention, and

FIG. 8 is a flowchart showing the steps in the method of manufacturing the structure using the system of FIG. 7.

FIG. 1 shows a composite structural component comprising a non-planar member 1 having a pattern of alternating front projections 3 and rear projections 5, without substantial flat areas therebetween. The projections are frustoconical with substantially flat tops 7. Each projection has a height of 20 mm and a flat top having a diameter of 15 mm. The interpitch, i.e. distance between two projections extending from the same face of the sheet, is 70 mm. The non-planar member 1 is bonded to a planar skin 11 which forms a skin.

A rough estimate shows that the planar skin 11 increases the resistance to flexion by a factor of five. Further increases in resistance may be obtained by increasing the density of the projections, increasing the level of adhesion between the non-planar member and the skin or by appropriate selection of the material of the non-planar member or the skin.

A five-fold increase in resistance may alternatively be obtained by stacking two non-planar members together but leads to a more complicated structure. Sandwiching the non-planar member 1 between two planar skins may provide twice the increase in resistance to flexion. However, as set out above, the addition of a single planar skin 11 provides a sufficient increase in resistance and a simple structure than the sandwich structure.

FIG. 2 shows that each projection 3,5 has a pitch region in which the non-planar member 1 is inclined at an angle θ of approximately 45 degrees to the median plane 9 at a position of maximum steepness of the pitch region. As is shown in FIG. 2, the median plane 9 is a notional plane which locally represents the position of the non-planar member with the projections smoothed out.

FIG. 3 is an alternative composite structural component comprising a non-planar member 21 which is bonded to a planar skin. 11. The non-planar member is substantially similar to that of FIG. 1 except that the front and rear projections 23,25 having different dimensions. In FIG. 3, both front and rear projections 23, 25 have a height of 30 mm and a flat top 27 having a diameter of 10 mm. The interpitch is 50 mm and each projection has a pitch region inclined at an angle θ approximately 26.5 degrees to the median plane.

FIGS. 4, 5a, 5b and 5c illustrate a generalised non-planar member 31 which may be used in the embodiments of FIGS. 1 or 3. The non-planar member 31 has a pattern of alternating front projections 33 and rear projections 35 both of which are frustoconical with substantially flat tops 37.

The characteristics of the pattern and the projections may be selected from the following table:

| | Height | Diameter | Interpitch | Angle A |
|---|---|---|---|---|
| | H (mm) | D (mm) | p (mm) | (degrees) |
| Geometry 1 | 20 | 15 | 70 | 45 |
| Geometry 2 | 10 | 9 | 35 | 40 |
| Geometry 3 | 20 | 12.5 | 50 | 32 |
| Geometry 5 | 10 | 12.5 | 50 | 51.34 |
| Geometry 6 | 10 | 12.5 | 30 | 14 |
| Geometry 7 | 30 | 10 | 50 | 26.5 |
| Geometry 8 | 15 | 12.5 | 50 | 40 |
| Geometry 9 | 7.5 | 3.125 | 12.5 | 22.6 |
| Geometry 10 | 12.5 | 12.5 | 50 | 45 |
| Geometry 11 | 10 | 7.5 | 35 | 45 |
| Geometry 12 | 15 | 11.25 | 52.5 | 45 |
| Geometry 13 | 25 | 18.75 | 87.5 | 45 |
| Geometry 14 | 30 | 22.5 | 105 | 45 |

Thus, as set out in the table the height of each projection may vary from 7.5 mm to 30 mm and the diameter of each flat top may vary from 3.125 mm to 22.5 mm. The interpitch may vary between 12.5 mm and 105 mm. The angle may vary between 14 and 51.34 degrees. Clearly there is flexibility in the selection of the geometry of the non-planar member.

FIGS. 6a and 6b show the bond 13 between the non-planar member 31 and the planar skin 11. In FIG. 6a, the bond 13 covers only the flat top 37 of a rear projection 35. In FIG. 6b, the bond 13 is extended to cover both the flat top 37 and a small portion of the curved side of the projection 35. In both embodiments the bond 13 may be adhesive, e.g. polyurethane or epoxy or may be by welding.

FIG. 7 shows a system for manufacturing a structural component according to the invention and FIG. 8 shows the steps in the method of manufacture which are as follows:
a) Unroll metal sheets 40,42 from two adjacent rolls 44;
b) Feed a first metal sheet 42 through a machine 46, e.g. a mangle to form a non-planar member 48, for example as shown in FIGS. 1 to 6b;
c) Join the second metal sheet 40 and the non-planar member 48 to form a composite structure by soldering at a soldering station 50, indicated schematically by arrows. The second metal sheet 40 forms a planar skin on one surface of the non-planar member 48. Alternatively, the soldering station 50 may be replaced by a welding station or a machine which applies then activates, e.g. by heat or pressure, a layer of adhesive between the second metal sheet 40 and the non-planar member 48;
d) Optionally, the structure may then be anodised at high temperature.

The advantages of the proposed structural component are:
1) The material may be selected so the component is cheap compared to prior structural components.
2) The material may be selected so the component is waterproof.
3) The material may be selected so the component also functions as a thermal or sound insulator.

1. A composite structural component for use in bearing a static load, consisting of a non-planar member and a planar skin which is bonded to one side of the non-planar member characterized in that the non-planar member is in the form of a sheet which has a pattern of projections extending from both faces of the sheet of the non-planar member to form alternating front and rear projections of substantially similar predetermined shape extending in front of and behind a median plane of the sheet.

2. A composite structural component according to claim 1, wherein parameters of the component are selected from the group consisting of geometry of each projection, material of the sheet and/or skin, thickness of the sheet and/or skin, nature of the bond between the non-planar member and skin and extent of contact between the non-planar member and skin to provide a high load-bearing capacity and high resistance to shear.

3. A composite structural component according to claim 1, wherein the planar skin is attached to at least 80% of the projections which extend from one face of the sheet of the non-planar member.

4. A composite structural component according to claim 1, wherein the projections cover at least 80% of a surface of the non-planar member leaving no substantial areas therebetween.

5. A composite structural component according to claim 1, wherein the planar skin is formed from a material selected from the group consisting of aluminium, alloys where aluminium is the predominant component and thermoplastics.

6. A composite structural component according to claim 1, wherein the sheet of the non-planar member is formed from a material selected from the group consisting of aluminium, alloys where aluminium is the predominant component and thermoplastics.

7. A method of making a composite structural component comprising:
providing a blank of sheet material;
acting on the blank to deform the blank into a non-planar member; and
bonding a planar skin to only one side of the non-planar member;
characterized in that the blank is deformed so that the non-planar member has a pattern of projections extending from both faces of the sheet of the non-planar member to form alternating front and rear projections of substantially similar predetermined shape extending in front of and behind a median plane of the sheet.

8. A method according to claim 7, comprising providing the blank of sheet material and the planar skin on two adjacent rolls and unrolling the blank and skin simultaneously.

9. A method according to claim 7, comprising soldering the planar skin to the non-planar member.

10. A method according to claim 7, comprising anodising the structural component at high temperature.
